(19) United States
(12) Patent Application Publication
(10) Pub. No.: US 2022/0087476 A1
(43) Pub. Date: Mar. 24, 2022

(54) CLOSED TANK FRYER

(71) Applicant: PITCO FRIALATOR, INC., Bow, NH (US)

(72) Inventors: Jared C. Perkins, Chester, NH (US); Karl M. Searl, Newmarket, NH (US)

(73) Assignee: PITCO FRIALATOR, INC., Bow, NH (US)

(21) Appl. No.: 17/424,748

(22) PCT Filed: Jan. 27, 2020
(86) PCT No.: PCT/US2020/015181

§ 371 Date: Jul. 21, 2021

Related U.S. Application Data
(60) Provisional application No. 62/797,706, filed on Jan. 28, 2019.

(51) Int. Cl. A47J 37/12

(52) U.S. Cl. CPC A47J 37/128

(57) ABSTRACT

A tank closure assembly for a deep fryer is provided. The tank closure assembly includes a motor driver actuator that is adapted to actuate the tank closure assembly between an open position and a closed position and a plurality of pistons coupled to the motor. In addition, lift arms are removably coupled to respective pistons from the plurality of pistons. An actuation support structure having at least one actuation track is adapted to allow the lift arms to move along the actuation support structure during actuation of the tank closure assembly. Further, a fryer lid is removably coupled to a bottom portion of the lift arms and a cooking carriage is removably coupled to a bottom portion of the fryer lid.

### FIELD OF TECHNOLOGY

The present application relates to deep fryers, and in particular to deep fryers for frying food.

### BACKGROUND

Frying apparatus are known for frying foods in a frying vat in a closed environment under pressure. Generally, fryers that fry in a closed environment are known as “pressure fryers.” Pressure frying enables moisture in a food product, e.g. chicken, to boil at a higher temperature, which speeds up cooking times. In protein foods, like chicken, pressure frying may result in less moisture from the food being lost in the cooking process. The pressurized frying results in protein that is cooked more quickly and has lost less moisture or flavor. It has been asserted that pressure frying also results in healthier protein foods because less of the moisture in the food is replace by frying oil.

Pressure fryers, however, require design and construction considerations for handling high pressures. That is, fryer vats and the components for locking a lid down to the frying vat must withstand high pressure. Gaskets that handle high temperatures and high pressures must be utilized and maintained to avoid problems with pressure fryers, and potential safety hazards. Robust and often complex lid locking mechanisms must be implemented to create the high pressure, high temperature cooking environment, and enable ease of access to load the fryer with food and remove cooked food from the high pressure, high temperature environment. Strict design tolerances for lids, lid locks and pressurized vats and seals must be adhered to for making pressure fryers safe in use.

Open fryers are known to fry foods as well, albeit at higher temperatures. Open fryers generally will not have a lid so the frying environment is exposed. Moisture may not be maintained in the cooking environment or cooked product. The cooking medium, e.g., cooking oil, may have lesser useful life due to exposure to an open environment, and cooking at generally higher temperatures for longer cooking times.

### SUMMARY

The present disclosure provides a non-pressurized closed tank fryer that has a non-pressurized lid to help maintain moisture in the cooking environment without the complexities of a pressurized vessel and associated high-pressure components. To facilitate further ease of cooking over conventional pressure fryers, the closed tank fryer according to the disclosure includes a lid that is integrated with a liftable carriage that carries food into and out of the cooking medium or oil. A coordinated lift mechanism may be implemented for manual (e.g., an operator pushing one or more lift buttons), or automated (e.g. under software program control) lifting of the cooking carriage and lid.

According to the disclosure, the closed lid tank fryer comprises a tank closure assembly with a motor adapted to actuate the tank closure assembly between an open position and a closed position. A plurality of pistons are coupled to the motor. Lift arms are removably coupled to respective pistons of the plurality of pistons. An actuation support structure has at least one actuation track adapted to allow the lift arms to move along the actuation support structure. A fryer lid is removably coupled to a bottom portion of the lift arms, and a cooking carriage is removably coupled to a bottom portion of the fryer lid. The closed lid tank fryer with the disclosed tank closure assembly maintains moisture in the closed, non-pressurized cooking environment to help seal in natural flavors and juices and sealed out oil resulting in less absorbed oil. A further result is shorter cooking times at lower temperatures. Better oil life may result as well, as cooking oil stays cleaner longer.

Other features and advantages of the present disclosure will become more apparent to those skilled in the art from the following description of detailed embodiments of the disclosure that have been shown and described by way of illustration. As will be realized, the disclosed subject matter is capable of other and different embodiments, and its details are capable of modification in various respects. Accordingly, the drawings and description are to be regarded as illustrative in nature and not as restrictive.

### BRIEF DESCRIPTION OF THE DRAWINGS

Embodiments of devices, systems, and methods are illustrated in the figures of the accompanying drawings, which are meant to be exemplary and non-limiting, in which like references are intended to refer to like or corresponding parts, and in which:

FIG. 1 is a first perspective view illustrating a deep fryer system with a closed cooking tank in an open position according to the disclosure.

FIG. 2 is a front view illustrating a deep fryer system with a closed cooking tank in an open position according to the disclosure.

FIGS. 3A-3C are perspective views illustrating an actuation support structure for a deep fryer system with a closed cooking tank according to the disclosure.

FIGS. 4A-4B are side views illustrating a deep fryer system with a closed cooking tank in a closed position according to the disclosure.

FIG. 5 is a flow diagram illustrating an overview of a method of use for a deep fryer system with a closed cooking tank according to the disclosure.

### DETAILED DESCRIPTION

The present disclosure provides a controlled cooking system with a closed cooking tank that allows the deep fryer system to efficiently and quickly cook a food product. In one exemplary use, the controlled cooking system, such as a deep fryer system, with a tank closure assembly to form a closed cooking tank may be used to retain heat within the cooking tank, such as a cooking vat in deep fryers, while continuously exhausting pressure and moisture in a controlled manner from the cooking tank. The use of the closed cooking tank may provide an energy efficient way of retaining heat to decrease cooking time and energy consumption by the controlled cooking system while cooking food products within the closed tank in a moisture regulated environment.

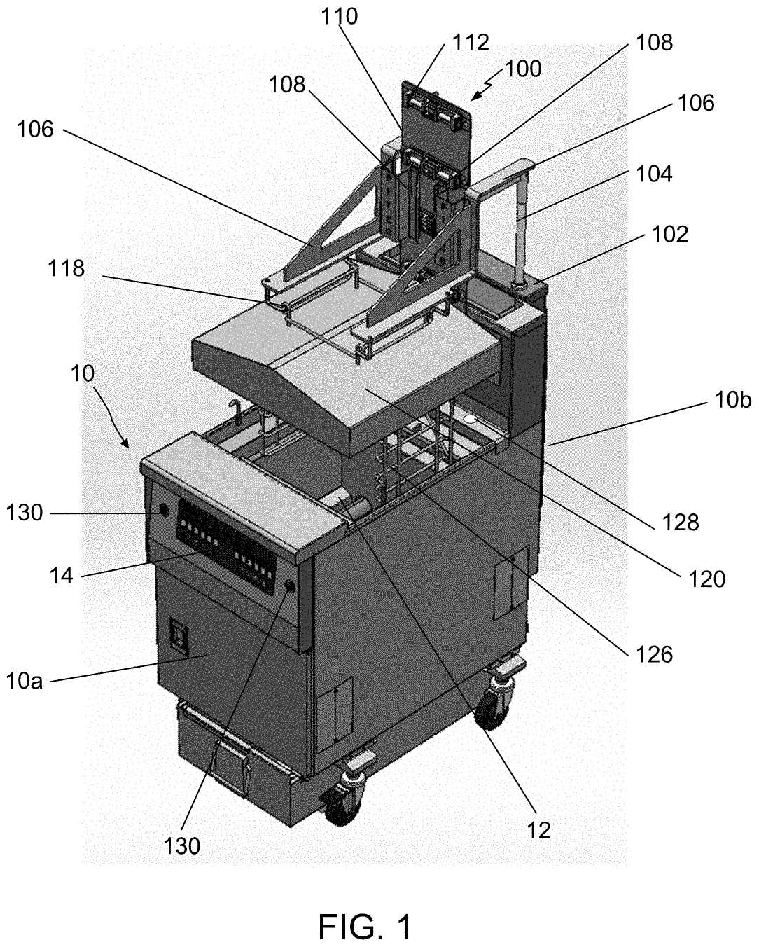

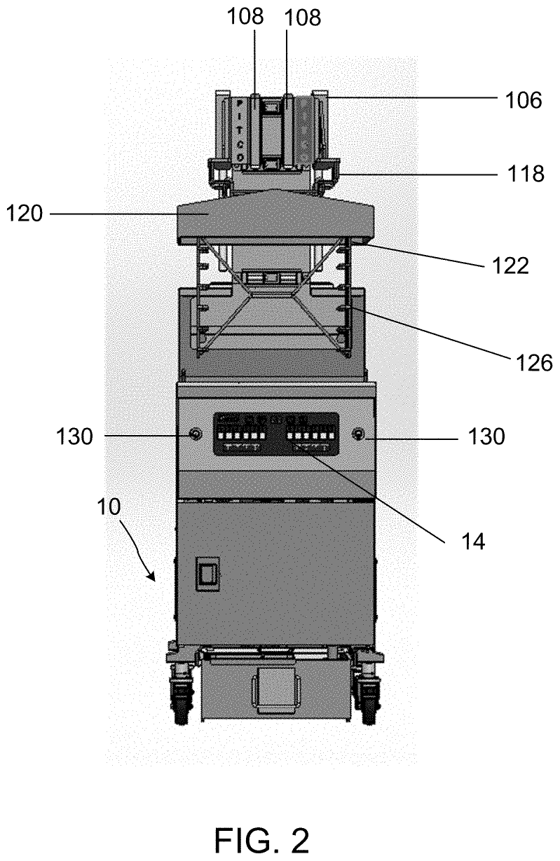

FIGS. 1 and 2 illustrate a deep fryer 10 that includes a tank closure assembly 100 that can be used to retain heat within a vat of frypot 12 of the deep fryer while controlling the exhausting of moisture and pressure from the vat 12. The deep fryer system 10 may also have a plurality of vats 12. In addition, the deep fryer system 10 may have electrical/electronic control components 14 disposed on a front side 10a of the deep fryer 10.

The deep fryer 10 has a tank closure assembly 100. The tank closure assembly 100 includes a motor driven actuator 102 that may be adapted to drive the tank closure assembly 100. The motor driven actuator 102 may be coupled to a back portion, i.e. back side, 10b that is opposite of the front side 10a, as illustrated in FIG. 1. The motor driven actuator 102 may be a worm gear linear actuator or any of various other devices capable of driving the tank closure assembly 100.

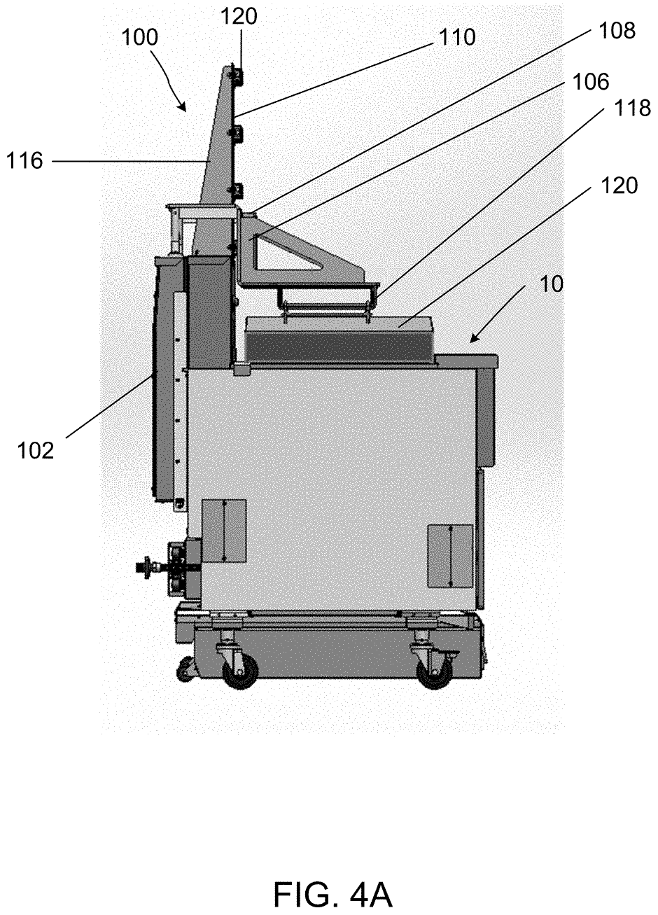

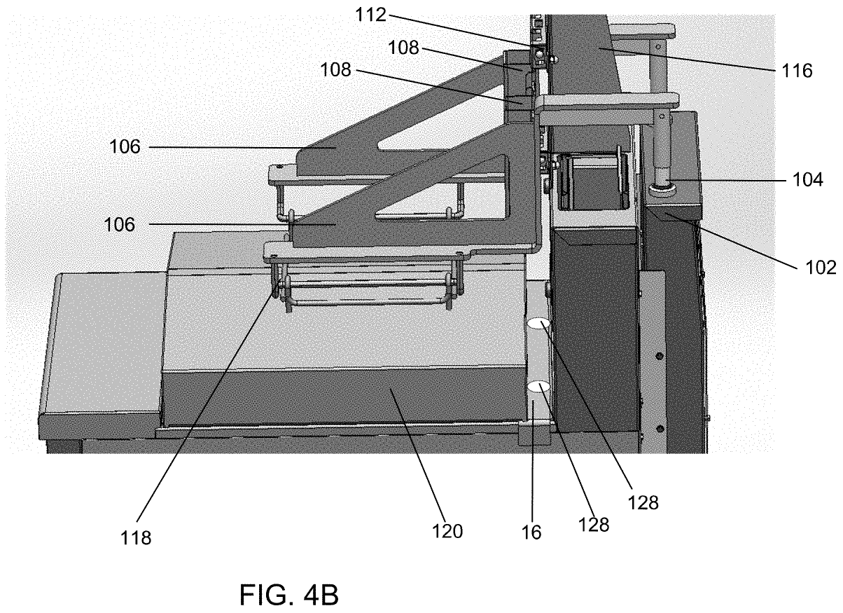

The motor driven actuator 102 is coupled to at least one piston 104. Each piston 104 extends in a substantially upward direction from the motor driven actuator 102 and removably couples to a lift arm 106 at a second end of the piston 104 that is opposite of the first end. The pistons 104 may be adapted to move in a substantially linear upward and downward fashion to actuate the tank closure assembly 100 between an open position (as shown in FIGS. 1 and 2) and a closed positon (best seen in FIGS. 4A and 4B).

Each lift arm 106 may extend from the pistons 104 in a direction towards the front side 10a of the deep fryer 10 to allow the tank closure assembly 100 to substantially completely cover the vat 12. The lift arms 106 may each include a first pair of travelers 108 and a second pair of travelers 109, that are adapted to actuate in substantially parallel fashion, on an actuation support structure 110, between an up position where the tank closure assembly 100 is open, and a down position, where the tank closure assembly 100 is closed.

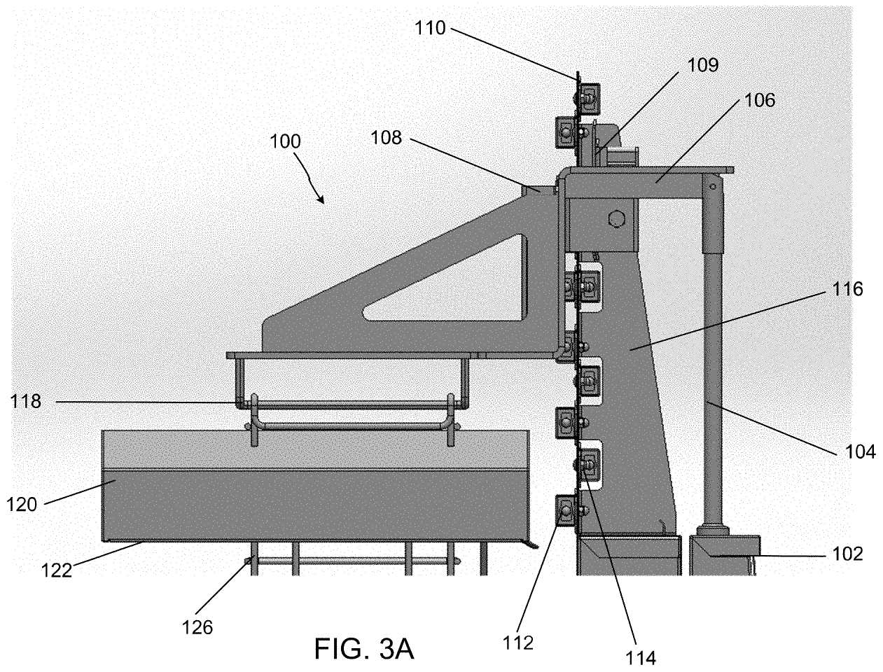

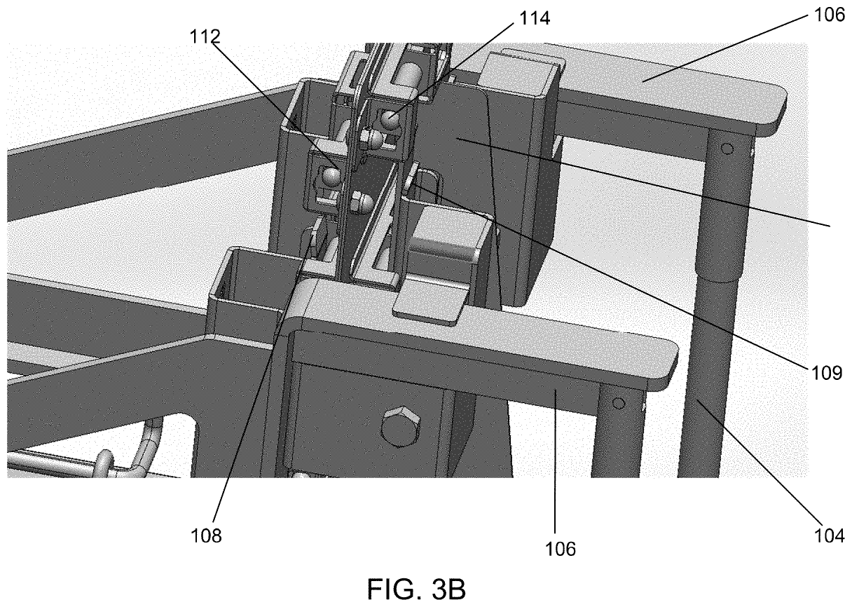

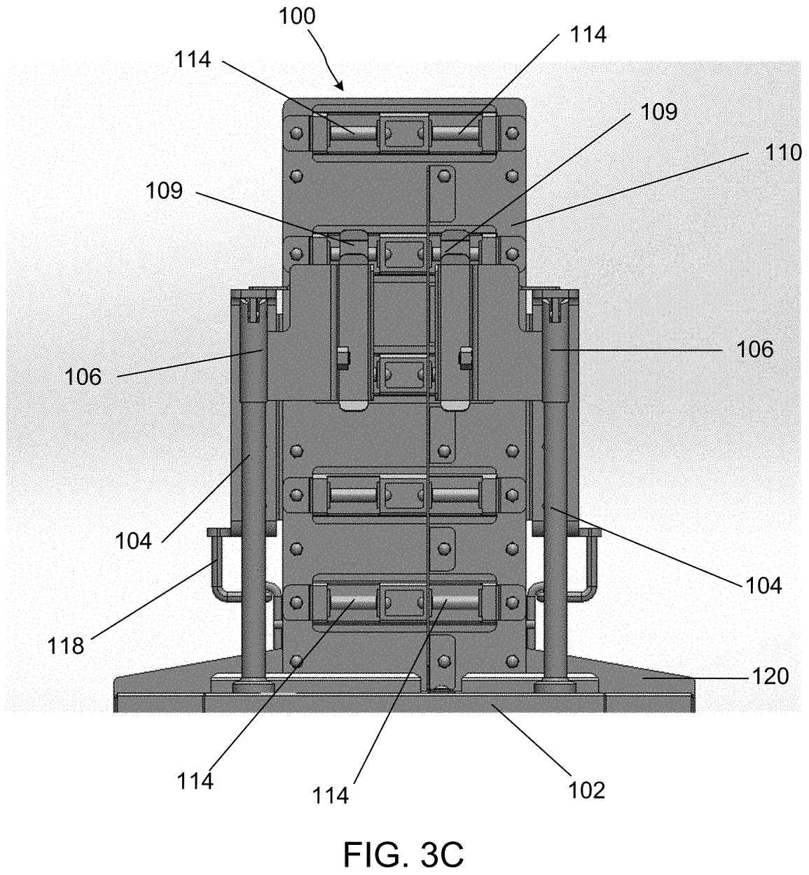

The actuation support structure 110 may be coupled to a top of the deep fryer 10. The actuation support structure 110, shown in more detail in FIGS. 3A-3C, may have a first actuation track 112 and a second actuation track 114 adapted to guide the travelers 108, 109 and maintain an orientation of the tank closure assembly 100 during actuation. As shown in FIGS. 3A-3C, the first actuation track 112 may be disposed on a first side, e.g. a front side, of the actuation support structure 110. Further, the second actuation track 114 may be disposed on a second side, opposite from the first side, e.g. a back side, of the actuation support structure 110. The first and second actuation tracks 112, 114 may be a plurality of nylon rollers or any other component capable of use with the traveler 108 to facilitate smooth actuation of the actuation support structure 110. In addition, the actuation support structure 110 may have a support flange 116 adapted to provide addition structural support to the support structure 110. The support flange 116 may be formed on the second side of the actuation support structure 110.

Each lift arm 106 may also have a lid hanger 118 disposed on a bottom portion of the lift arm 106. A fryer lid 120 may be removably coupled (or fixed) to the lid hanger 118. The lid 120 may be adapted to substantially cover the vat 12 when the tank closure assembly 100 is in the closed position. While in the closed position, the lid may retain heat within the vat 12 and exhaust pressure and moisture from the vat 12 in a controlled manner while the deep fryer 10 is cooking a food product. The lid 120 may have a collection channel 122 formed along a bottom edge of the lid 120.

The collection channel 122 may be adapted to collect moisture that forms as condensation on the interior of the lid 120 while the food product is cooked in the vat 12. The geometry of the lid 120, along with gravity, may direct moisture into the collection channel 122. As moisture is collected by the collection channel 122, the moisture is further directed to one (or more) corner(s) of the lid 120 through the channel 122. Once funneled to the corner(s) of the lid 120, the moisture collected by the collection channel is drained from the collection channel 122. The lid 120 may be positioned to capture more or less moisture as a function of the position of the lid above the vat.

The lid 120 may also have a carriage hanger 124 that is adapted to removably couple a cooking carriage 126 to the lid 120. The carriage hanger 124 and the lid hanger 118 may be a substantially similar structure. The cooking carriage 126 may be food holding racks or it may be used to hold racks loaded with food items to be cooked by the deep fryer 10. In addition, the cooking carriage 126 may move in the substantially same manner as the other parts of the tank closure assembly 100 when the assembly 100 moves between the two positions.

The deep fryer 10 may also have at least one fire suppression nozzle 128. The fire suppression nozzles 128 may be adapted to disperse fire suppression material if/when a fire is detected in the deep fryer 10. The fire suppression nozzles 128 may be disposed on a backsplash 16 of the deep fryer 10.

The electrical control components 14 may include at least one lift assembly control component 130 adapted to control actuation of the tank closure assembly 100 between the open position and the closed position. The lift assembly control component 130 may be positioned such that an operator of the deep fryer 10 is safely positioned to be clear of the actuation of the tank closure assembly 100 to avoid injuries to the operator.

Further, the lift assembly control components 130 may be adapted to actuate the tank closure assembly 100 when an operator activates the lift assembly control components 130. For example, when pressure is applied to the lift assembly control components 130 by an operator, the tank closure assembly will begin to actuate to the closed position. In addition, if there is a change in the pressure applied to the operator while the tank closure assembly 100 is actuating from the open position to the closed position and the tank closure assembly 100 has not reached the fully closed position, the tank closure assembly 100 may be adapted to automatically return to the open position to prevent injuries to the operator and keeps items from being caught in the actuation of the tank closure assembly 100.

Furthermore, when one or more assembly control components 130 are included, the assembly control components 130 may be adapted to actuate the tank closure assembly 100 when sufficient pressure is applied to each of the one or more assembly control components 130. Additionally, should the pressure applied to any one of the one or more assembly control components 130 change while the tank closure assembly 100 is actuating from the open position to the closed position and the tank closure assembly 100 has not reached the fully closed position, the tank closure assembly 100 may be adapted to automatically return to the open position, as well.

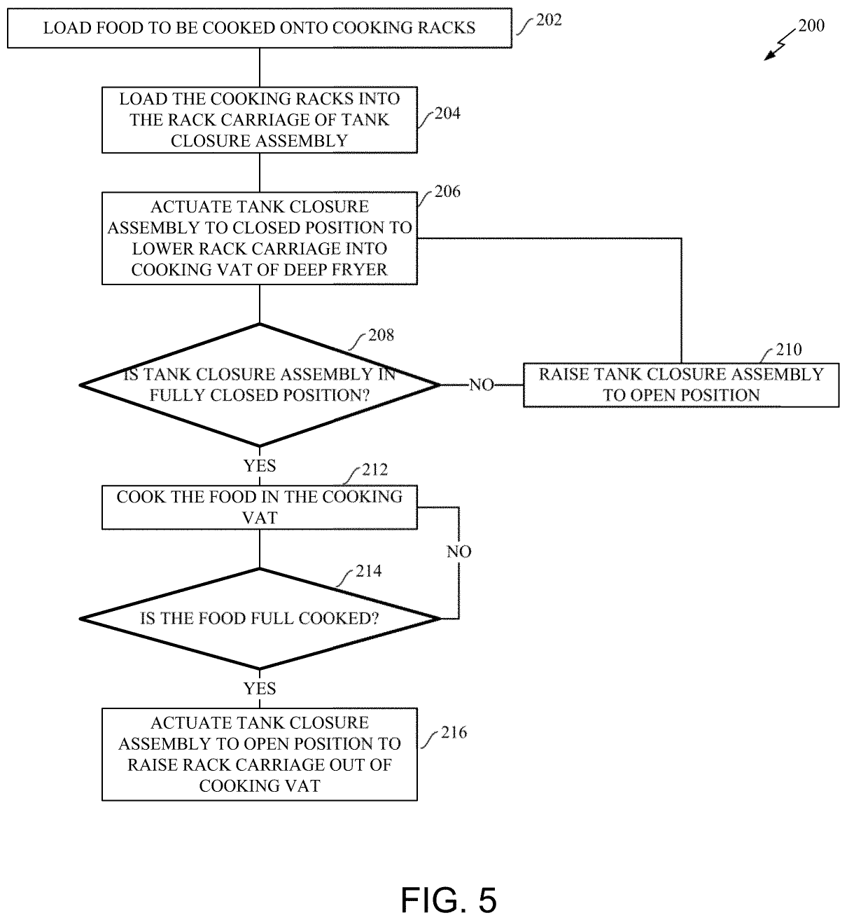

FIG. 5 illustrates an overview of a method 200 of use for a deep fryer system with a tank closure assembly according to the disclosure. The method includes loading food, that is to be cooked in the deep fryer, onto cooking racks 202. The cooking racks loaded with food are loaded into a rack carriage within the tank closure assembly 204. Once the racks are loaded onto the rack carriage of the tank closure assembly, the tank closure assembly is actuated from an open position to a closed position, using assembly control components, to lower the rack carriage into a cooking vat of the deep fryer 206.

Further, it is determined whether the tank closure assembly has been fully actuated to the closed position 208 when the assembly control components are disengaged by a user. If the tank closure assembly has not been fully actuated to the closed position, the tank closure assembly may be raised back to the open position 210 and the tank closure assembly will need to be actuated by a user using the assembly control components until the tank closure assembly is fully actuated to the closed position. When the tank closure assembly reaches the fully closed position, the food loaded onto the rack carriage is cooked within the vat of the deep fryer system 212. In addition, it may also be determined whether the food is fully cooked 214. When it is determined the food is not fully cooked, the tank closure assembly may remain closed and cause the food to continue to be cooked in the vat until the food is fully cooked. When it is determined the food is fully cooked, the tank closure assembly is actuated from the closed position back to the open position to raise the rack carriage of the cooking vat 216 and complete the cooking of the food

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

While various embodiments are disclosed herein, it should be understood that the invention is not so limited and modifications may be made without departing from the disclosure. The scope of the disclosure is defined by the appended claims, and all devices that come within the meaning of the claims, either literally or by equivalence, are intended to be embraced therein.

What is claimed is:

1. A tank closure assembly for a deep fryer, comprising:
a motor driver actuator adapted to actuate the tank closure assembly between an open position and a closed position;
a plurality of pistons coupled to the motor driver actuator;
lift arms removably coupled to respective pistons of the plurality of pistons;
an actuation support structure having at least one actuation track adapted to allow the lift arms to move along the actuation support structure;
a fryer lid removably coupled to a bottom portion of the lift arms; and
a cooking carriage removably coupled to a bottom portion of the fryer lid.

2. The tank closure assembly of claim 1, wherein the motor driver actuator comprises:
a motor; and
a worm gear assembly adapted to actuate the pistons.

3. The tank closure assembly of claim 1, further comprising at least one assembly control component adapted to control actuation of the tank closure assembly.

4. The tank closure assembly of claim 1, further comprising at least one fire suppression nozzle adapted to disperse fire suppression material when a fire is detected.

5. The tank closure assembly of claim 1, wherein the actuation support structure comprises:
a first actuation track on a first side of the actuation support structure; and
a second actuation track on a second side of the actuation support structure.

6. The tank closure assembly of claim 5, wherein the lift arms comprise:
a first traveler adapted to move along the first actuation track during actuation of the tank closure assembly; and
a second traveler adapted to move along the second actuation track during actuation of the tank closure assembly.

7. The tank closure assembly of claim 1, wherein the fryer lid comprises a collection channel adapted to collect moisture within the deep fryer and drain the collected moisture from a corner of the fryer lid.

8. A method of actuating a tank closure assembly comprising:
loading a food onto a cooking rack;
loading the cooking rack into a rack carriage removably coupled to a lid;
activating an actuation support structure to automatically actuate the lid between an open position and a closed position.

9. The method of actuating the tank closure assembly of claim 8, further comprising:
operating a lift assembly control to engage a motor driven actuator;
actuating at least one piston coupled to the motor driven actuator; and
actuating at least one lift arm coupled to the at least one piston and the lid.

10. The method of actuating the tank closure assembly of claim 9, further comprising:
guiding at least one pair of travelers operatively coupled to the at least one piston along at least one actuation track.

11. The method of actuating the tank closure assembly of claim 9, further comprising applying a pressure to the lift assembly control using at least one lift assembly control component adapted to detect the pressure.

12. The method of actuating the tank closure assembly of claim 11, further comprising determining there has been a change in the pressure and actuating the lid to the open position.

13. The method of actuating the tank closure assembly of claim 10, further comprising guiding the at least one pair of travelers in a substantially parallel fashion between an up position when the lid is in the open position and a down position when the lid is in the closed position.

14. The method of actuating the tank closure assembly of claim 8, further comprising:
cooking the food;
determining the food is fully cooked; and
actuating the lid to the open position.

15. A lift assembly control for a fryer comprising:
a tank closure assembly comprising at least one lift arm;
at least one lift assembly control component operatively configured to be actuated by an operator of the fryer to control the at least one lift arm; and
wherein the at least one lift assembly control component is positioned on the fryer in a positon where in order to be actuated the operator of the tank closure assembly is safely positioned to be clear of actuated components of the tank closure assembly.

16. The lift assembly control of claim 15, wherein the lift assembly control is configured to detect a change in pressure applied by the operator to the at least one lift assembly control component; and
the lift assembly control is configured to actuate the tank closure assembly to an open position in response to the change in pressure.

17. The lift assembly control of claim 16, wherein the lift assembly control is configured to determine whether the tank closure assembly has been fully actuated to a closed position when a change in pressure is detected; and
the lift assembly control is further configured to actuate the tank closure assembly to the open position if the tank closure assembly has not been fully actuated to the closed position.

18. The lift assembly control of claim 15, wherein a plurality of the at least one lift assembly control component must be activated to actuate the tank closure assembly.

19. The lift assembly control of claim 18, wherein the lift assembly control is configured to detect a change in pressure applied by the operator to the plurality of the lift assembly control components;
the lift assembly control is configured to determine whether the tank closure assembly has been fully actuated to a closed position when the change in pressure is detected; and
the lift assembly control is further configured to actuate the tank closure assembly to an open position when a change in pressure is detected and the tank closure assembly has not been fully actuated to the closed position.

20. The lift assembly control of claim 15, wherein the lift assembly control determines whether a food is fully cooked and remains closed until the food is fully cooked.
